(19) United States
(12) Patent Application Publication
(10) Pub. No.: US 2007/0237902 A1
(43) Pub. Date: Oct. 11, 2007

(54) Adhesion-promoting compositions and methods of promoting adhesion between a coating and a substrate

(76) Inventors: Kaliappa G. Ragunathan, Pittsburgh, PA (US); Robert E. Jennings, Elwood City, PA (US); Bruce A. Connelly, Gibsonia, PA (US); Deborah E. Hayes, Verona, PA (US); Shengkui Hu, Baden, PA (US); Truman F. Wilt, Clinton, PA (US); Ronald R. Ambrose, Pittsburgh, PA (US)

Correspondence Address: PPG INDUSTRIES, INC.;Intellectual Property Department, One PPG Place, Pittsburgh, PA, 15272, US

(21) Appl. No.: 11/401,146

(22) Filed: Apr. 10, 2006

(51) Int. Cl. B05D 7/00

(52) U.S. Cl. 427/407.1; 525/193

(57) ABSTRACT

Compositions comprising the reaction product of a polymer comprising a polyol, a polyisocyanate and/or a polyamine and a compound comprising a chlorendate group are disclosed. Also disclosed are methods of improving adhesion between a coating composition and a substrate by applying the adhesion promoting compositions of the present invention to the substrate.

### FIELD OF THE INVENTION

The present invention relates to compositions comprising the reaction product of a polymer comprising a polyol, a polyisocyanate and/or a polyamine and a compound comprising a chlorendate group, and to methods of using the same to improve the adhesion of a coating to a substrate.

### BACKGROUND OF THE INVENTION

It can be difficult to formulate coating compositions that can adequately adhere to various substrates like metal and plastic, particularly when these substrates have an existing coating layer. Primers can be applied to certain substrates in certain circumstances to increase the coating's adherence to the substrate, but a single primer is usually not effective on a variety of substrates.

In the area of automotive coatings, conversion coatings may be applied to a substrate in order to improve a coating composition's ability to adhere to the substrate. Conversion coatings that deposit as a microthin coating and react with the substrate come in two types. The first and most common type is an aqueous solution of strong mineral acids that enhances adhesion by chemically reacting with the metallic substrates in a process called “etching”. The second type of conversion coating is a dispersion in organic solvents. For optimum performance, this type of conversion coating often contains heavy metal pigments such as strontium chromate.

In other areas coatings may be applied to flexible substrates. There are often problems associated with the adhesion of coatings to this type of substrate, particularly those made from thermoplastic and thermosetting polymeric materials. Such coatings, once applied, may flake, crack, and/or otherwise be removed from the substrate as a result of time, chemical exposure, mechanical stresses and the like.

A composition that promotes adhesion of a coating composition to a substrate is therefore desired.

### SUMMARY OF THE INVENTION

The present invention is directed to adhesion promoting compositions comprising the reaction product of a polymer and a compound comprising a chlorendate group, wherein the polymer comprises a polyol, a polyisocyanate and/or a polyamine, and wherein the polyol comprises an epoxy polyol, an acrylic polyol, a polyurethane polyol, a polybutadiene polyol and/or a polyether polyol.

Further, the present invention is directed to methods for improving adhesion between a coating and a substrate by applying the adhesion promoting compositions of the present invention to a substrate.

### DETAILED DESCRIPTION

As used herein, unless otherwise expressly specified, all numbers such as those expressing values, ranges, amounts or percentages may be read as if prefaced by the word “about”, even if the term does not expressly appear. Any numerical range cited herein is intended to include all sub-ranges subsumed therein. Plural encompasses singular and vice versa. For example, while reference is made herein to “a” chlorendate group, “a” polyol, “a” polyisocyanate, and “a” polyamine, one or more of these components may be used in the practice of the invention. Also, as used herein, the term “polymer” is meant to refer to prepolymers, oligomers and both homopolymers and copolymer; the prefix “poly” refers to two or more.

The present invention is generally directed to compositions that can be used for promoting adhesion between a coating and a substrate and/or between layers of coatings. The present adhesion promoting compositions (sometimes referred to herein as “adhesion promoters,” “adhesion promoting compositions,” and like terms) comprise the reaction product of a polymer and a compound comprising a chlorendate group (sometimes referred to herein as “reaction product”). The term “polymer” as used herein refers to the group of compounds comprising polyols, polyisocyanates, and/or polyamines. By chlorendate group, it is meant a compound having the formula:

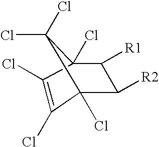

wherein R1 and/or R2 can form an ester linkage upon reaction with a polyol, and/or an amide linkage upon reaction with a polyisocyanate and/or polyamine. R₁ and R₂ can together be a cyclic moiety. Suitable compounds having a chlorendate group include, for example, chlorendic acid and/or anhydride, chlorinated polycyclic dicarboxylic acids and anhydrides, and the like.

Suitable polyols for use in the present invention include acrylic polyols, polyurethane polyols, polyether polyols, polybutadiene polyols, and/or mixtures of any of the foregoing. In one embodiment, the polyol is an acrylic polyol. In another embodiment, the acrylic polyol may have a hydroxyl number ranging from 6 to 1000. In another embodiment the hydroxyl number may range from 10 to 280. In yet another embodiment, the hydroxyl number may range from 25 to 140. As used herein, the “hydroxyl number” is defined as number of milligrams of potassium hydroxide equivalent to the hydroxyl content of one gram of solid resin (mg KOH/gram).

One suitable acrylic polyol for use in the present invention can be prepared from hydroxyl alkyl esters of (meth)acrylic acid and one or more other polymerizable ethylenically unsaturated monomers such as alkyl esters of (meth)acrylic acid including, but not limited to, methyl (meth)acrylate, ethyl (meth)acrylate, isobornyl acrylate, butyl (meth)acrylate and 2-ethyl hexylacrylate, and vinyl aromatic compounds such as styrene, alpha-methyl styrene, and vinyl toluene. As used herein, “(meth)acrylate” and like terms are intended to include both acrylate and methacrylate.

In one embodiment of the present invention, the polyol may be derived from ethylenically unsaturated monomers. These monomers can include, for example, hydroxyl functional vinyl or acrylic monomers. One example of a hydroxyl functional vinyl monomer is vinyl alcohol. Suitable examples of hydroxyl functional acrylic monomers include hydroxy ethyl (meth)acrylate, hydroxy butyl (meth)acrylate, hydroxy propyl (meth)acrylate, hydroxyl caprolactone (meth)acrylate monomers like TONE M100 and TONE M201, commercially available from Dow Chemical, and hydroxyl polyalkoxy monomers available from Cognis corporation and sold under the name BISOMER. Other hydroxyl functional acrylic monomers may comprise the reaction products of glycidyl (meth)acrylate with monocarboxylic acids, examples of monocarboxylic acids include versatic acid, and the reaction products of (meth)acrylic acid with monoepoxy compounds such as a monglycidyl ester of a branched carboxylic acid, which is sold under the name CARDURA E10 and is commercially available from Shell Chemical.

Examples of the suitable polyols shown above can be found in numerous patents and publications. For example, suitable hydroxyl functional (meth)acrylic polyols are disclosed in U.S. Pat. No. 6,316,119 at column 2, lines 51-61. Suitable hydroxyl functional polyols derived from epoxy polyols are disclosed in U.S. Pat. No. 4,913,972 at column 17, lines 38-61. Suitable polyurethane polyols are disclosed in U.S. Pat. No. 4,913,972 at column 17, line 62 to column 18, line 4. The portions of the above-cited references are hereby incorporated by reference. Suitable polybutadiene polyols are commercially available as poly BD and sold by Sartomer Company, and POLYTAIL H resins commercially available from Mitsubishi Chemical Corporation.

Examples of suitable polyisocyanates for use in the present invention include, for example, aromatic diisocyanates, such as 4,4′-diphenylmethane diisocyanate and toluene diisocyanate. Suitable aliphatic diisocyanates include, for example, straight chain aliphatic diisocyanates such as 1,6-hexamethylene diisocyanate. Also, cycloaliphatic diisocyanates may be employed and include, for example, isophorone diisocyanate and 4,4′-methylene-bis-(cyclohexyl isocyanate). Other polyisocyanates suitable for use in the present invention include, for example, 1,2,4-benzene triisocyanate and polymethylene polyphenyl isocyanates. Isocyanate functional polyurethanes prepared by reacting excess isocyanates with polyols and/or polyureas prepared by reacting excess isocyanates with polyamines or mixtures thereof can also be used in the present invention.

Examples of suitable polyamines for use in the present invention include acrylic polyamine polymers prepared from amino alkyl esters of (meth)acrylic acid, such as t-butylaminoethyl methacrylate and/or m-isopropenyl-α,α-dimethylbenzylamine) and one or more other polymerizable ethylenically unsaturated monomers such as alkyl esters of (meth)acrylic acid including, but not limited to, methyl (meth)acrylate, ethyl (meth)acrylate, butyl (meth)acrylate and 2-ethyl hexylacrylate, and vinyl aromatic compounds such as styrene, alpha-methyl styrene, and vinyl toluene. Polyoxyalkyl amines may also be employed. Examples of suitable polyoxyalkyl amines are commercially available under the trade name JEFFAMINE by Huntsman Corporation.

In one embodiment, the adhesion promoters of the present invention may comprise the reaction product of an acrylic polyol and a compound comprising a chlorendate group. In this embodiment, a reaction product may be synthesized by first reacting a monomer comprising a chlorendate group, such as, for example chlorendic anhydride and/or acid, with vinyl and/or acrylic hydroxyl monomers, such as, for example, hydroxyl ethyl (meth)acrylate, to produce vinyl and/or acrylic hydroxyl monomers comprising a chlorendate group, and subsequently forming the acrylic polymer with the vinyl and/or acrylic hydroxyl monomers comprising a chlorendate group.

It is also contemplated that in certain embodiments of the present invention the adhesion promoters may include reaction products comprising various mixtures of polyols, polyisocyanates, and/or polyamine polyols and various mixtures of compounds comprising a chlorendate group.

It will be appreciated that the reaction products of the present invention are distinct from the reaction products formed for use in UV cure applications.

Reaction products of the present invention may have a theoretical chlorine content from 5 to 47 percent based on the total weight of the reaction product. In certain embodiments, the chlorine content may range from 8 to 35 percent based on the total weight of the reaction product. In yet other embodiments, the chlorine content may range from 10 to 25 percent based on the total weight of the reaction product.

The reaction product according to the present invention may have an acid value ranging from 0 to 135. In certain embodiment, the acid value may range from 0 to 100. In yet other embodiments, the acid value may range from 0 to 65. As used herein, the term “acid value” is defined as number of milligrams of potassium hydroxide required to neutralize the acid groups in one gram of solid resin (mg KOH/gram).

In one embodiment, upon completion of the reaction of the chlorendate groups with hydroxyl groups, an excess of hydroxyl groups may remain. In another embodiment, upon completion of the reaction of the chlorendate groups with hydroxyl groups, an excess of acid groups may remain. In yet another embodiment, upon the completion of the reaction of chlorendate groups with hydroxyl groups, neither excess hydroxyl groups nor excess acid groups remain. In an embodiment where excess free acid groups remain, these acid groups may be partially or completely reacted with another reactive group. Suitable reactive groups reactive groups include, for example, epoxy compounds, amine and hydroxyl containing compounds.

In one embodiment, the adhesion promoting compositions according to the present invention may further comprise a chlorinated polyolefin. Chlorinated polyolefins for use in the present invention include those modified with an anhydride, such as, for example, maleic anhydride. In one embodiment, the reaction product may be attached to the chlorinated polyolefin by first attaching a polymer, as used herein, to the chlorinated polyolefin by polymerizing the monomers in the presence of the chlorinated polyolefin to produce a polymer/chlorinated polyolefin product and subsequently reacting a compound comprising a chlorendate group with the polymer/chlorinated polyolefin product. In another embodiment, an acrylic polyol is reacted with chlorinated polyolefin to produce an acrylic polyol/chlorinated polyolefin product that is subsequently reacted with a compound comprising a chlorendate group, such as chlorendic acid and/or chlorendic anhydride. In some embodiments, the chlorinated polyolefin is present in an amount ranging from 5 to 60 percent based on the total weight of the molecule comprising the reaction product and the chlorinated polyolefin. In other embodiments, the chlorinated polyolefin is present in an amount ranging from 15 to 40 percent based on the total weight of the molecule comprising the reaction product and the chlorinated polyolefin.

In another embodiment of the present invention, a chlorinated polyolefin may be incorporated into an adhesion promoting compositions by blending or mixing a chlorinated polyolefin with the reaction product. In some embodiments, the chlorinated polyolefin may be present in the adhesion promoting compositions in an amount ranging from 5 to 95 percent based on the total weight of the adhesion promoting composition. In certain embodiments, the chlorinated polyolefin is present in the composition from 40 to 60 percent based on the total weight of the adhesion promoting compositions. In other embodiments, the chlorinated polyolefin is present in the composition from 40 to 50 percent based on the total weight of the adhesion promoting compositions.

The adhesion promoting compositions of the present invention may be made having a solids content from 1 to 75 percent based on the total weight of the composition. In some embodiments, the adhesion promoters according to the present invention may be prepared having a “low solids” content. In such an embodiment, the adhesion promoting composition may have a solids content ranging from 1 to 20 percent based on the total weight of the adhesion promoting composition. In another embodiment, the solids content is from 1 to 10 percent based on the total weight of the composition and in other embodiments the solids content is from 3 to 7 percent based on the total weight of the composition.

The adhesion promoting compositions of the present invention may further comprise solvents. Suitable solvents for use in the present composition include water and/or organic solvents such as aromatic petroleum distillates like toluene, xylene, and aromatic blends; aliphatic solvents like cyclohexane and naphthas; ketones like acetone, methyl ethyl ketone, methyl isobutyl ketone, and methyl amyl ketone; alcohols like ethyl alcohol, propyl alcohol, and diacetone alcohol; mono- and dialkyl ethers of ethylene and diethylene glycol like ethylene glycol monoethyl ether, ethylene glycol monobutyl ether, ethylene glycol monoethyl ether acetate, diethylene glycol monobutyl ether, and diethylene glycol diethyl ether, acetates such as n-butyl acetate and 1-methoxy-2-propanol acetate; methyl benzene; 2-butanone; and mixtures thereof.

The adhesion promoting composition of the present invention may also include a colorant. As used herein, the term “colorant” means any substance that imparts color and/or other opacity and/or other visual effect to the composition. The colorant can be added to the adhesion promoting compositions in any suitable form, such as discrete particles, dispersions, solutions and/or flakes. A single colorant or a mixture of two or more colorants can be used in the adhesion promoting compositions of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the adhesion promoting compositions by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the adhesion promoting compositions, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in U.S. application Ser. No. 10/876,315 filed Jun. 24, 2004, which is incorporated herein by reference, and U.S. application Ser. No. 10/876,031 filed Jun. 24, 2004, which is also incorporated herein by reference.

Example special effect compositions that may be used in the adhesion promoting compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086B2, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting embodiments, a photosensitive composition and/or photochromic composition, which reversibly alters its color when exposed to one or more light sources, can be used in the compositions of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In one non-limiting embodiment, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In a non-limiting embodiment, the photosensitive composition and/or photochromic composition can be associated with and/or at least partially bound to, such as by covalent bonding, a polymer and/or polymeric materials of a polymerizable component. In contrast to some coating compositions in which the photosensitive composition may migrate out of the coating and crystallize into the substrate, the photosensitive composition and/or photochromic composition associated with and/or at least partially bound to a polymer and/or polymerizable component in accordance with a non-limiting embodiment of the present invention, have minimal migration out of the coating. Example photosensitive compositions and/or photochromic compositions and methods for making them are identified in U.S. application Ser. No. 10/892,919 filed Jul. 16, 2004 and incorporated herein by reference.

In general, the colorant can be present in the coating composition in any amount sufficient to impart the desired visual and/or color effect. The colorant, if used, may comprise from 1 to 65 weight percent of the present compositions, such as from 3 to 40 weight percent or 5 to 35 weight percent, with weight percent based on the total weight of the compositions.

Optionally, the adhesion promoting compositions of the present invention may include other coating additives such as, for example, rheological agents, fillers, reactive diluents, cross-linking agents, other film forming resins, plasticizers and the like. In some embodiments, the adhesion promoting compositions of the present invention are substantially or completely free of silane containing compounds. As used herein, the term “substantially free” means that the material being discussed is present in the composition, if at all, as an incidental impurity. In other words, the material does not affect the properties of the composition. As used herein, the term “completely free” means that the material is not present in the composition at all.

The present invention is also directed to methods for improving adhesion between a substrate and a coating, comprising applying to a substrate any of the adhesion promoting compositions described above. The coating can be any subsequently added coating, used for decorative, protective and/or functional purposes, such as those described below. The methods of the present invention are particularly effective in promoting adhesion over EVA (ethyl vinyl acetate) foam; polyurethane; fiberglass reinforced plastic; plastic including thermoplastic and/or thermoset materials as known to those in the art, and as described below; and/or metal. It will be appreciated that many of these substrates are flexible substrates. As used herein, “flexible substrate” and like terms refer to substrates that can undergo mechanical stresses, such as bending or stretching and the like, without significant irreversible change. In certain embodiments, the flexible substrates are compressible substrates. “Compressible substrate” and like terms refer to substrates capable of undergoing a compressive deformation and returning to substantially the same shape once the compressive deformation has ceased. The term “compressive deformation” means a mechanical stress that reduces the volume at least temporarily of a substrate in at least one direction. “EVA foam” can comprise open cell foam and/or closed cell foam. “Open cell foam” means that the foam comprises a plurality of interconnected air chambers; “closed cell foam” means that the foam comprises discrete closed pores. EVA foam can include flat sheets or slabs or molded EVA foams, such as shoe midsoles. Different types of EVA foam can have different types of surface porosity. Molded EVA can comprise a dense surface or “skin”, whereas flat sheets or slabs can exhibit a porous surface. Polyurethane substrates according to the present invention include aromatic, aliphatic and hybrid (hybrid examples are silicone polyether or polyester urethane and silicone carbonate urethane) polyester or polyether based thermoplastic urethanes By “plastic” is meant any of the common thermoplastic or thermosetting synthetic materials, including thermoplastic olefins (“TPO”) such as polyethylene and polypropylene and blends thereof, thermoplastic urethane, polycarbonate, sheet molding compound, reaction-injection molding compound, acrylonitrile-based materials, nylon, and the like. A particular plastic is TPO that comprises polypropylene and EPDM (ethylene propylene diene monomer). “Metals” include all metals such as steel, galvanized steel, cold rolled steel, Mg, Al, Ti, and the like.

All or part of the substrate can be coated using the adhesion promoting compositions, which may be applied by any means known in the art. Examples of suitable application techniques include, but are not limited to, brushing, wiping, spraying, dipping or flowcoating. The adhesion promoters can be used in any amount to yield improved adhesion between the substrate and any additional coating layers applied.

Depending on the needs of the user, and the particular substrate involved, the substrate may be pretreated prior to application of the adhesion promoting compositions. Such pretreatment may include, for example, plasma treatment, flame treatment, abrasive sanding, UV irradiation and/or chemical cleaning such as solvent cleaning.

The adhesion promoting coating compositions may be applied to a substrate as described herein and may be applied to a substrate that is at least partially coated with an existing coating or can be applied between successive layers of a multi-layer coating system.

After application of the adhesion promoting composition, it can be cured, such as by flashing at room temperature and then optionally baked. In certain embodiments, the baking operation can be carried out, for example, at a temperature in the range of from 100° to 120° F., for 5 to 25 minutes. In other embodiments the cure temperature may be significantly higher. It is well within the skill of one practicing in the art to determine appropriate cure conditions, particularly taking in to consideration the substrate to which the adhesion promoter is being applied. The dry film thickness of the adhesion promoter can range from 0.01 to 1.0 mils, and is usually from 0.1 to 0.4 mils. In some applications, the adhesion promoter may be applied at a dry film thickness of from 0.05 to 0.20 mils. In one embodiment, the adhesion promoter is applied at 0.05 to 0.1 mils.

Typically, a primer and/or a basecoat composition different from the adhesion promoting composition may be subsequently applied on top of the adhesion promoters described herein. The primer and/or basecoat may each be pigmented or unpigmented. A clear coating composition may optionally be applied to the basecoat. The primer and/or basecoat and/or clearcoat may be applied after baking the film of the adhesion promoting composition, or may be applied in a “wet-on-wet” configuration prior to the baking operation; that is, the adhesion promoter can be cured or uncured prior to the application of subsequent coating layers. Any suitable primer, basecoat and/or clearcoat can be used based upon the needs of the user and the particular substrate, and the particular use for the substrate. Adhesion of the subsequent coating layers (i.e. primer, basecoat, and/or clearcoat) will be enhanced as compared to a substrate coated without the adhesion promoter described herein. In some embodiments, the adhesion promoting compositions described herein are applied as a separate layer. In other embodiments, the adhesion promoter described herein can be added to another coating as an additive to improve the adhesion promoting properties of that coating. For instance, the adhesion promoting compositions of the present invention can be added to a primer to improve the adhesion of the primer to the substrate and/or to improve the adhesion of a coating applied over the primer. In other embodiments, the adhesion promoting compositions may be added to a coating that is applied as a direct gloss topcoat. For example, the adhesion promoters may be added to a two-component polyurethane as a direct gloss topcoat that is applied directly to a substrate or to a primed substrate. The adhesion promoting compositions of the present invention can be added as an additive to another coating in an amount ranging from 1 to 30 percent based on the weight of solid resin. In another embodiment, the adhesion promoter can be added in amount ranging from 2 to 10 percent based on the weight of solid resin or in an amount ranging from 5 to 10 percent based on the weight of solid resin.

### EXAMPLES

Illustrating the invention are the following examples that are not to be considered as limiting the invention to their details. All parts and percentages in the examples, as well as throughout the specification, are by weight unless otherwise indicated.

Examples 1-7 illustrate the preparation of a polymer comprising a chlorendate group according to the present invention. Examples 2, 3, 5, 6 and 8 further incorporate a chlorinated polyolefin. Example 7 illustrates replacing a portion of the chlorendic anhydride with the reaction product of polyisobutene and maleic anhydride. Finally, Example 8 shows a composition where the chlorendic anhydride has been completely replaced.

### Example 1

A reaction flask was equipped with a stirrer, thermocouple, nitrogen inlet and a condenser. The charges to the reaction flask are shown in Table 1 below. Charge A was then added and stirred under heating to reflux temperature of 135° C. to 142° C. under a nitrogen atmosphere. To the refluxing charge A, charge B and charge C were simultaneously added over a period of two hours. The reaction mixture was held at reflux condition for an hour and then cooled to 90° C. Charge D was then added and the reaction mixture was held at 90° C. for 205 min and subsequently cooled to 30° C.

### Example 2

A reaction flask was equipped with a stirrer, thermocouple, nitrogen inlet and a condenser. The charges to the reaction flask are shown in Table 1 below. Charge A was then added and stirred under heating to a temperature of 110° C. under a nitrogen atmosphere. The charge B and charge C additions were simultaneously started over two and three hours, respectively. After the completion of the addition of charge C, the reaction mixture was held at 110° C. for an hour and then cooled to 90° C. Charge D was then added and heated to 100° C. The reaction mixture was held at 100° C. for 208 min and subsequently cooled to 30° C.

### Example 3

A reaction flask was equipped with a stirrer, thermocouple, nitrogen inlet and a condenser. The charges to the reaction flask are shown in Table 1 below. Charge A was then added and stirred under heating to reflux temperature of 135° C. to 142° C. under a nitrogen atmosphere. To the refluxing charge A, charge B and charge C were simultaneously added over two hours. The reaction mixture was then held at reflux condition for an hour and then cooled to 90° C. Charge D was then added and reaction mixture was held at 90° C. for 385 min and subsequently cooled to 30° C.

### Example 4

A reaction flask was equipped with a stirrer, thermocouple, nitrogen inlet and a condenser. Charge A was added to the flask and stirred with heat to a temperature of 135-142° C. under a nitrogen atmosphere. The charge was permitted to reflux. Charge B and charge C where added simultaneously to the flask over a three-hour time period. The reaction mixture was held at reflux condition for an hour and subsequently cooled to 80° C. Charge D was then added. The reaction mixture was then maintained at 90° C. for 150 minutes and subsequently cooled to 30° C.

### Example 5

A reaction flask was equipped with a stirrer, thermocouple, nitrogen inlet and a condenser. Charge A was added to the flask and stirred with heat to reflux temperature of 135-142° C. under a nitrogen atmosphere. Charge B and charge C where added simultaneously to the flask over a two-hour time period. The reaction mixture was held at reflux condition for an hour and subsequently cooled to 90° C. Charge D was then added. The reaction mixture was then maintained at 100° C. for 300 minutes and subsequently cooled to 30° C.

### Example 6

A reaction flask was equipped with a stirrer, thermocouple, nitrogen inlet and a condenser. Charge A was added to the flask and stirred with heat to reflux temperature of 135-142° C. under a nitrogen atmosphere. Charge B and charge C where added simultaneously to the flask over a two-hour time period. The reaction mixture was held at reflux condition for an hour and subsequently cooled to 90° C. Charge D was then added. The reaction mixture was the maintained at 90° C. for 195 minutes and subsequently cooled to 30° C.

### Example 7

A reaction flask was equipped with a stirrer, thermocouple, nitrogen inlet and a condenser. Charge A was added to the flask and stirred with heat to a temperature of 135° C. under a nitrogen atmosphere. The charge was permitted to reflux. Charge B and charge C where added simultaneously to the flask over a three-hour time period. The reaction mixture was held at reflux condition for two hours and subsequently cooled to 90° C. Charge D was then added over ten minutes. The reaction mixture was then maintained at 136° C. for 240 minutes and subsequently cooled to 30° C.

### Example 8

A reaction flask was equipped with a stirrer, thermocouple, nitrogen inlet and a condenser. Charge A was added to the flask and stirred with heat to a temperature of 135° C. under a nitrogen atmosphere. The charge was permitted to reflux. Charge B and charge C where added simultaneously to the flask over a three hours The reaction mixture was held at reflux condition for an hour and subsequently cooled to 80° C. Charge D was then added. The reaction mixture was then maintained at 100° C. for 155 minutes and subsequently cooled to 30° C.

TABLE 1*

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Charge A | | | | | | | | |
| Xylene | 295 | 1427.6 | 295.0 | 336.6 | 295.0 | 295 | 875.2 | 250.4 |
| CP343-1¹ | — | 392.7 | 64.4 | — | 160.7 | 144.9 | — | 68.9 |
| Charge B | | | | | | | | |
| Xylene | 86.3 | 540.0 | 86.3 | — | 86.3 | 86.3 | — | 94.7 |
| 2-Ethylhexyl Acrylate | 115.4 | 439.0 | 44.2 | 200.0 | 70.2 | 20.1 | 520.3 | 77.0 |
| Isobornyl acrylate | 115.4 | — | 44.2 | 200.0 | — | 20.1 | 520.2 | — |
| Hydroxy propyl methacrylate | 24.5 | 151.9 | 69.4 | — | 24.3 | 37.2 | — | 26.6 |
| Hydroxyethyl methacrylate | — | — | — | 139.5 | — | — | 362.6 | — |
| Charge C | | | | | | | | |
| t-Butylperacetate | — | — | — | 35.0 | — | — | 91.0 | — |
| LUPEROX 26² | 3.1 | 19.6 | 3.1 | — | 3.1 | 3.1 | — | 3.4 |
| Xylene | 101.4 | 634.5 | 101.4 | 220.0 | 101.4 | 101.4 | 572.0 | 111.3 |
| Charge D | | | | | | | | |
| Chlorendic anhydride | 63.6 | 397.7 | 96.6 | 404.5 | 63.6 | 96.6 | 1051.6 | — |
| GLISSOPAL SA³ | — | — | — | — | — | — | — | 200 |
| Analytical results | | | | | | | | |
| % solids | 36.9 | 32.1 | 35.5 | 64.8 | 36.8 | 36.9 | 64.6 | 45.6 |
| Acid value - mg KOH/gm⁴ | 12.6 | 16.0 | 21.8 | 42.8 | 13.8 | 12.6 | 45.4 | 11.9 |

*all weights in grams
¹CP343-1 is chlorinated polyolefin (100% solids) commercially available from Eastman chemicals
²LUPEROX 26 is t-Butyl peroxy-2-ethylhexanoate commercially available from Arkema Inc.
³Reaction product of polyisobutene and maleic anhydride commercially available under the designation GLISSOPAL SA sold by BASF.
⁴polymer solution in xylene

Below are adhesion promoting compositions listed as Samples 10-26 that illustrate adhesion promoting compositions.

The compositions in Table 2 include Samples 10-15. Samples 10-13 utilize the products of Examples 1-3, as indicated. Sample 15 is a comparative composition and is a commercially available chlorinated polyolefin reduced with xylene. The chlorinated polyolefin is designated CP343-1 (100% solids) sold by Eastman Chemicals. Sample 14 is also a comparative composition and is a commercially available adhesion promotor sold by PPG Industries under the name ONE CHOICE that incorporates an acrylic modified chlorinated polyolefin where the acrylic does not include a chlorendate group.

TABLE 2*

| | Sample | Sample | Sample | Sample | Sample | Sample |
|---|---|---|---|---|---|---|
| | 10 | 11 | 12 | 13 | 14 | 15 |
| CP343-1 | — | 3.7 | — | — | — | 10 |
| Product of | 10 | 10 | — | — | — | — |
| Example 1 | | | | | | |
| Product of | — | — | 15 | — | — | — |
| Example 2 | | | | | | |
| Product of | — | — | — | 15 | — | — |
| Example 3 | | | | | | |
| ONE CHOICE | — | — | — | — | 25 | — |
| Xylene | 36.9 | 60 | 33.2 | 38.2 | 35 | 90 |

*All weights in grams.

Table 3 as set forth below illustrates the tested properties of the Samples 10-15. The substrates, as indicated, were scuffed with an abrasive SCOTCHBRITE pad by 3M to show an adhesion comparison of a scuffed (before application of the adhesion promoter) versus an unscuffed substrate. One coat of the adhesion promoting composition was applied with a spray gun to a dry film thickness ranging from 0.05 mils to 0.15 mils. The compositions were permitted to “flash” at ambient temperatures for 10 minutes. An acrylic lacquer basecoat was then applied. The basecoat used is commercially available from PPG Industries, Inc. and sold under the designation D9700. The basecoat was permitted to flash for 10 minutes upon which the acrylic urethane clearcoat D893 commercially available from PPG Industries Inc. was applied. The coatings were allowed to cure at ambient temperature for one week prior to testing. The gloss was measured at 60° according to ASTM 0427. Distinctness of Image (DOI) was measured using a C-Box according to ASTM 0743. “Adhesion” comprised a crosshatch and tape pull according to ASTM 0625. The results of the adhesion test are reported as percent (%) of adhesion. “Humidity” represents adhesion after 10 days of exposure in a 100° F./100% relative humidity cabinet according to ASTM 0880. Results of the humidity test are reported as percent (%) adhesion. Samples 10-13 utilizing the products of Examples 1-3 show as good, and in some cases better, adhesion than the comparative Samples 14-15 as shown in Table 3.

TABLE 3

| Compo- | | | | | | |
|---|---|---|---|---|---|---|
| sition | Substrate | Scuff | Gloss | DOI | Adhesion | Humidity |
| Sample 10 | Polypropylene | Yes | 88 | 70 | 70 | 50 |
| Sample 10 | Polypropylene | No | 88 | 70 | 50 | 0 |
| Sample 10 | TPO⁴ | Yes | 88 | 65 | 100 | 60 |
| Sample 10 | TPO | No | 88 | 60 | 100 | 0 |
| Sample 11 | Polypropylene | Yes | 88 | 60 | 100 | 100 |
| Sample 11 | Polypropylene | No | 88 | 60 | 100 | 50 |
| Sample 11 | TPO | Yes | 88 | 65 | 100 | 100 |
| Sample 11 | TPO | No | 89 | 60 | 100 | 100 |
| Sample 12 | Polypropylene | Yes | 88 | 60 | 100 | 100 |
| Sample 12 | Polypropylene | No | 88 | 60 | 100 | 100 |
| Sample 12 | TPO | Yes | 88 | 65 | 100 | 100 |
| Sample 12 | TPO | No | 87 | 65 | 100 | 100 |
| Sample 13 | Polypropylene | Yes | 87 | 65 | 100 | 100 |
| Sample 13 | Polypropylene | No | 88 | 60 | 100 | 95 |
| Sample 13 | TPO | Yes | 88 | 60 | 100 | 100 |
| Sample 13 | TPO | No | 89 | 60 | 100 | 100 |
| Sample 14 | Polypropylene | Yes | 88 | 65 | 100 | 100 |
| Sample 14 | Polypropylene | No | 88 | 60 | 85 | 70 |
| Sample 14 | TPO | Yes | 88 | 60 | 100 | 100 |
| Sample 14 | TPO | No | 89 | 60 | 100 | 100 |
| Sample 15 | Polypropylene | Yes | 88 | 60 | 50 | 20 |
| Sample 15 | Polypropylene | No | 88 | 60 | 10 | 0 |
| Sample 15 | TPO | Yes | 89 | 65 | 100 | 100 |
| Sample 15 | TPO | No | 89 | 60 | 100 | 50 |

⁴Polyolefin/EPDM blend

Samples 16-18 utilize the products of Example 4 and Example 5 as indicated. Sample 19 is the commercially available chlorinated polyolefin CP 343-1 and is included for comparative purposes. The adhesion promoters were applied to a substrate and were subsequently coated with a coating composition as indicated below. Table 4 provides the compositional makeup of the tested Samples.

TABLE 4*

| Component: | Sample 16 | Sample 17 | Sample 18 | Sample 19 |
|---|---|---|---|---|
| Product of | 15.44 | 9.28 | — | — |
| Example 4 | | | | |
| Product of | — | — | 27.16 | — |
| Example 5 | | | | |
| CP 343-1 | — | 4.00 | — | 10.00 |
| Xylene | — | 86.72 | 72.84 | 76.52 |
| DT870⁵ | 84.56 | — | — | — |
| Methyl amyl Ketone | — | — | — | 13.48 |
| Total: | 100.00 | 100.00 | 100.00 | 100.00 |

*All weights in grams
⁵DT870 is a solvent blend commercially available from PPG Industries, Inc.

Samples 16-19 were spray-applied over pre-coated metal substrates having one of the following unsanded, OE (original equipment) finishes, all of which are available from PPG Industries, Inc.:
Coating 1: Acrylic carbamate and/or polyester carbamate with melamine binders. Coating is sold commercially under the designation DCT8000.
Coating 2: Acrylic polyols and melamine binders. Coating is sold commercially under the designation DCT1002B.
Coating 3: Polyester acids and epoxy binders. Coating is sold commercially under the designation DCT5000.
Coating 4: Polyols with polyisocyanate binders. Coating is sold commercially under the designation WTKR2000.
Coating 5: Polyurea, electrodeposited primer coat. Coating is sold commercially under the designation ED6060.

Samples 16-19 were applied to each substrate and air-dried for 30 minutes after which time a black base coat, commercially available from PPG Industries, Inc. and sold under the designation GLOBAL D9700, was sprayed applied. The basecoats were air-dried for 15 minutes and were subsequently coated via spray application with a two-component urethane clear coat, commercially available from PPG Industries, Inc. and sold under the designation CONCEPT DCU2042. The substrates were dried/cured at ambient temperature and humidity for one week prior to humidity testing. Each panel was placed in a 100° F./100% relative humidity chamber for 10 days. Immediately after exposure, each test panel was scribed to create a 100 square grid test area according to ASTM 0880. The scribed area was then taped by impressing the tape onto the coating. The tape, available commercially from 3M and sold as under the name SCOTCH 898, was then forcibly peeled away from the scribe area. The results of the test are illustrated in Table 5 below. The values in Table 5 are represented as percent (%) retention of each coating after adhesion testing. Sample 17 and Sample 18 provided adhesion that substantially matched or exceeded that of the control (Sample 19).

TABLE 5

| Sample | Coating 1 | Coating 2 | Coating 3 | Coating 4 | Coating 5 |
|---|---|---|---|---|---|
| 16 | 0% | 0% | N/D* | 0% | N/D |
| 17 | 100% | 99% | 100% | 95% | 87% |
| 18 | 95% | 75% | 100% | 100% | N/D |
| 19 | 25% | 0% | 100% | 100% | N/D |

*N/D—Not Done

The following Samples 20-24 were prepared and tested on a flexible substrate. The substrate was an ethyl vinyl acetate foam commonly used as a midsole for athletic shoes. The compositions of Samples 20-26 were made with the adhesion promoters of Examples 6-8 as shown in Table 6. The midsoles were cleaned with a solvent blend and allowed to air dry. The adhesion promoters were applied to the substrate by either brushing or wiping, as indicated in Table 6. The adhesion promoters were either air dried for 10 minutes or forced dried for one hour at 100° to 120° F. A basecoat having a polyol with a methyl diisocyante cross-linker was then applied. Such a base coat is available from PPG Industries Inc. and sold under the designation XPM61423S. Cross-hatch adhesion was checked after 24 hours according to ASTM D3359. As is apparent, the adhesion promoters of the present invention save better adhesion than substrates that were not treated with the present compositions.

TABLE 6

| | | | | Cross-Hatch Adhesion on | | |
|---|---|---|---|---|---|---|
| | | | DRY | Midsole (Location on Midsole)* | | |
| Sample | SYSTEM | APPLICATION | CYCLE | Back | Middle | Front |
| 20 | 5% of Example 7** | Brush | Air | 5 | 5 | ND*** |
| 21 | 2% CPO 343/2% of | Brush | Air | 5 | 5 | ND |
| | Example 7** | | | | | |
| 22 | Product of | Spray | 1′ at | 5 | 3 | ND |
| | Example 6 | | 100°-120° F. | | | |
| 23 | Product of | Spray | 1′ at | 1 | 0 | ND |
| | Example 8 | | 100°-120° F. | | | |
| 24 | Clean Substrate: | Brush | Air | 2 | 1 | ND |
| | no adhesion | | | | | |
| | promoter | | | | | |

*Adhesion rating: 5 = no pick-off, 0 = 100% pick off.
**Solvent blend added to make a 100% solution; solvent blend = 50/50 blend of methylcyclohexane/n-butyl acetate.
***N/D—Not Done

We claim:

1. A composition comprising:
a) the reaction product of a polymer and a compound comprising a chlorendate group, wherein the polymer comprises a polyol, a polyisocyanate and/or a polyamine, and wherein the polyol comprises an epoxy polyol, an acrylic polyol, a polyurethane polyol, a polybutadiene polyol and/or a polyether polyol.

2. The composition of claim 1 wherein the chlorendate group is derived from chlorendic acid and/or chlorendic anhydride.

3. The composition of claim 1 wherein the polyol comprises acrylic polyol.

4. The composition of claim 1 wherein the polymer comprises polyisocyanate.

5. The composition of claim 1 wherein the polymer comprises polyamine.

6. The composition of claim 1 further comprising a chlorinated polyolefin.

7. The composition of claim 6 wherein the chlorinated polyolefin is blended into the adhesion promoting composition.

8. The composition of claim 6 wherein the chlorinated polyolefin is attached to the reaction product.

9. The composition of claim 1 wherein the reaction product comprises an excess of hydroxyl groups or an excess of acid groups.

10. The composition of claim 1 wherein the reaction product comprises a chlorine percentage ranging from 5 to 47 percent based on the total weight of the reaction product.

11. The composition of claim 1 wherein the reaction product has an acid value ranging from 0 to 135 mg KOH/gram of solid resin.

12. An adhesion promoting composition comprising:
a) the reaction product of a polymer comprising an acrylic polyol and chlorendic acid and/or chlorendic anhydride.

13. The composition of claim 12 further comprising a chlorinated polyolefin.

14. The composition of claim 13 wherein the chlorinated polyolefin is blended into the adhesion promoting composition.

15. The composition of claim 13 wherein the chlorinated polyolefin attached to the reaction product.

16. The composition of claim 12 wherein the reaction product comprises an excess of hydroxyl groups or an excess of acid groups.

17. A method for improving adhesion between a coating composition and a substrate comprising:
applying to at least a portion of the substrate the composition of claim 1.

18. A method for improving adhesion between a coating composition and a substrate comprising:
applying to at least a portion of the substrate the composition of claim 12.

19. The method of claim 17 wherein the chlorendate group is derived from chlorendic acid and/or chlorendic anhydride.

20. The method of claim 17 wherein the polyol is an acrylic polyol.

21. The method of claim 17 wherein the adhesion promoting composition further comprises a chlorinated polyolefin.

22. The method of claim 17 wherein at least a portion of the substrate comprises a pre-existing coating.

23. The method of claim 17 wherein the adhesion promoting coating composition is applied to the substrate so as to have a dry film thickness of 0.01 to 1.0 mils.

24. The method of claim 17 wherein the substrate comprises metal.

25. The method of claim 17 wherein the substrate comprises plastic.

26. The method of claim 25, wherein the plastic comprises polypropylene and optionally EPDM.

27. The method of claim 17 wherein the substrate is flexible.

28. The method of claim 17 wherein the substrate is EVA foam.

29. The method of claim 17 wherein the composition is added to a coating composition prior to application to the substrate.
